(19) United States
(12) Patent Application Publication
(10) Pub. No.: US 2002/0056820 A1
(43) Pub. Date: May 16, 2002

(54) Valve control device

(76) Inventors: Urban Altenrenger, Ingolstadt (DE); Markus Binder, Koesching (DE); Georg Dorfinger, Geimersheim (DE); Richard Hoffmann, Geimersheim (DE); Willy Kring, Ingolstadt (DE); Klaus Schirmer, Ingolstadt (DE); Roberto Schlenker, Ingolstadt (DE)

Correspondence Address: FASSE PATENT ATTORNEYS, P.A., P.O. BOX 726, HAMPDEN, ME, 04444-0726, US

(21) Appl. No.: 09/870,421

(22) Filed: May 30, 2001

(30) Foreign Application Priority Data
May 30, 2000 (DE) 100 26 564.2

(51) Int. Cl. F16K 47/00

(52) U.S. Cl. 251/127

(57) ABSTRACT

2.1. Existing valve control devices are set up in housings that feature a cover and a frame in which the valve spools are embedded. Between the cover and the frame, there is the circuit carrier with the electronic components. With the new valve control device, there is no longer to be any need for a housing, and the manufacturing process is to be simplified.

2.2. In order to save the housing, the valve control device is embedded together with the circuit carrier. The compound itself provides the housing of the valve control device. In the manufacturing process, following the mechanical and electrical connection of spools and circuit carrier, the spools are positioned in the embedding tool, and the complete arrangement is then embedded preferably with epoxy resin.

2.3. Due to their high reliability such valve control devices are suitable for antilock braking systems, anti-slip control systems, electronic brake servos, and electronic stabilizing programs in motor vehicles.

The invention concerns a valve control device in accordance with the preamble of patent claim 1. Such a valve control device is, for example, an electronic control unit for an antilock braking system (ABS) in a motor vehicle, where the brake liquid operating the wheel brakes is controlled by means of two valves per wheel. The valves are operated by an electric magnet.

The invention also concerns a process for the manufacture of such a valve control device.

### BACKGROUND OF THE INVENTION

A known ABS system such as described in EP 0499 670 A1, features a housing with a housing frame and a cover. In the housing frame, valve spools are embedded in a yielding fashion. This is effected by positioning the valve spools in their location relative to the housing frame and filling in the spaces with a compound. The component parts of the valve spool such as a wrapped spool body and its surrounding yoke ring are filled in with a compound before being fitted into the housing frame. Then the valve spools are fitted into the housing and fixed into their position by embedding.

The disadvantage here, however, is that several embedding processes are necessary. The compound is not used as a component part of the housing but only for the yielding embedding of the spools. This yielding embedding, in turn, is only used to compensate tolerances if the valve unit is later fitted onto the valve control device. Further housing components are necessary in order to be able to provide a watertight encapsulation of the entire valve control device.

In DE 42 32 205 A1, in a housing frame of the valve control device, the components of a valve spool such as the wrapped spool body, yoke ring, and the valve spool itself will be embedded in yielding fashion by injection moulding with a compound in a single process and then fitted as the housing bottom to a circuit carrier. On the other side, an additional cover is fitted over the circuit carrier so that the valve control device is provided with watertight encapsulation.

The disadvantage with this valve control device is that the embedded arrangement—due to the unprotected circuit carrier—also requires an additional housing as the soft compound alone does not provide a reliable protection against environmental influences. The separate housing, in its turn, requires sealing lips and ventilation diaphragms that protect the circuit carrier against humidity.

The object of the invention is to provide a valve control device that is watertight, features few housing parts and can be manufactured and fitted easily and at low cost.

### SUMMARY OF THE INVENTION

According to the invention, the object is achieved by a valve control device with the characterising features of patent claim 1 and a process in accordance with patent claim 8. The valve control device according to the invention is completely embedded in compound. The circuit carrier and the valve spools are positively covered by a compound. The positive cover consisting of compound provides the housing of the valve control device, which on the one hand fixes the electronic and mechanical components in position, that is, it holds them in the required position and on the other hand encapsulates them in order to protect them against environmental influences, in particular, humidity. In the process for the manufacture of such a valve control device, the circuit carrier is connected to the electronic components and the spools are mechanically connected to each other; then the spools are fixed in position on the embedding tool, embedded, and finally hardened. Here, it is also possible to use different materials with different properties as a compound. After processing the compound can be hard and rigid or soft and elastic. However, it may also feature different properties in different places such as e.g. soft and elastic in the area of the spools and hard and rigid in the external area and in the area of the printed circuit board.

The advantages of the invention are that only one embedding process is still needed but no assembly process where several parts have to be put together in order to provide the valve control device with a watertight housing. This also does away with the need for testing, in particular with regard to housing leakage. Individual separate housing parts are no longer required. At the same time, there is no longer any need for flexible seals, sealing lips, and ventilation diaphragms.

Advantageous further embodiments of the invention result from the sub-claims. Here, yoke components or a metal plate, which also serves as a yoke component and/or is used for heat dissipation for the power components, can be addionally embedded into the compound. Also, in contrast to standard opinion, it is not a soft compound that is used but a compound which is hard and rigid after hardening. The spools will then be arranged immovably in the compound. Tolerance compensation will then no longer be effected via the movable arrangement of the spools in the compound but via the internal diameter of the spool. Also, in other advantageous embodiments, the yoke is designed as a C-shaped, bell-shaped, or U-shaped yoke and post-arranged on the spools after embedding. Furthermore, the mechanical connection between spool and circuit carrier can also represent the electrical connection.

### BRIEF DESCRIPTION OF THE DRAWINGS

In the following, the invention is to be explained in more detail by means of embodiment examples and the figures. The figures below show:

FIG. 1: Valve control device without metal plate

FIG. 2: Spool arrangement

FIG. 3a: Side view, spool body

FIG. 3b: Front view, spool body

FIG. 4a: Side view, yoke

FIG. 4b: Front view, yoke

FIG. 5: Valve control device with metal plate

FIG. 6: Spool arrangement

FIG. 7a: Side view, spool body

FIG. 7b: Front view, spool body

FIG. 8a: Side view, bell-shaped yoke

FIG. 8b: Front view, bell-shaped yoke

FIG. 9a: Side view, U-shaped yoke

FIG. 9b: Front view, U-shaped yoke

FIG. 10a: Yoke plate, seen from below

FIG. 10b: Cross-section of the yoke plate

### DESCRIPTION OF THE PREFERRED EMBODIMENTS

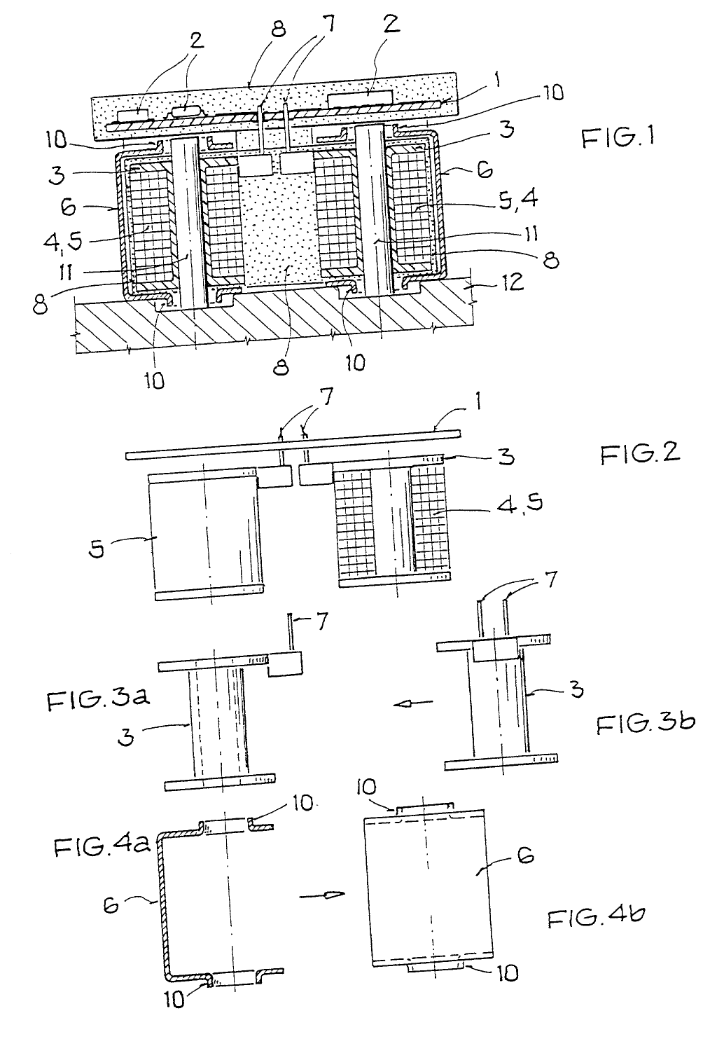

FIG. 1 shows an embedded valve control device without metal plate with the outline of a valve unit 12. In the compound 8, there is the circuit carrier 1, in particular a printed circuit board populated with the electronic components 2. The electronic components 2 may either be encapsulated in a housing or be mounted on the printed circuit board 1 as a blank chip which can also be protected by the compound 8. At the same time spools 5 are mounted on the circuit carrier 1 via the compound. The protective cover consisting of compound features different thicknesses and solidity in different places. The spacing between two spools 5 is completely filled in with compound 8. The remaining spool area that is the top side of the spool, its bottom and external side are only covered by a thin coating of compound 8. The circuit carrier 1 is covered by a somewhat thicker compound layer 8. In this figure, boundary layers between the individual embedded components are indicated. This is to suggest that the compound 8 may also consist of different materials whichmay again feature different properties. Within the spool area the compound 8 can be soft and elastic, and in the circuit carrier area it may be hard and rigid. In the area between the spools 5 and the circuit carrier 1 the compound 8 may only have low elastic properties. In order to simplify the further description of the application examples, it is assumed that the compound is homogeneous and features in all places the same properties, does not have any boundary areas, and becomes hard and rigid after processing. The spools surrounded by the compound, also designated as valve spools, consist of spool body 3 and windings 4 and represent the electric magnets by means of which the valves of valve unit 12 are operated via the valve domes 11. The electric spool connections 7, mounted on the side of the spool body 3, protrude into the printed circuit board 1. In this figure, two spools are shown that are facing each other so that their side-mounted spool connections 7 are located next to one another. This setup is particularly space-saving. The spools and the circuit carrier 1 are completely embedded, excluding the inside of the spool. In the inside of the spool, the spool body 3 is visible. The external surfaces of the spool body 3 and the spool windings 4 are positively covered by the compound 8. This embedded arrangement protects all components, in particular the electronic components 2, against unfavorable environmental conditions such as e.g. water, humidity, and dust. In this case, the compound 8 consists of epoxy resin. The compound 8 will become rigid when the arrangement has hardened. The embedded components such as spools 5, circuit carrier 1, electronic components 2 are fixed in position by the compound. With this setup, there is no longer any need for a housing. The compound 8 itself provides the housing. In the area between the spools 5 and the circuit carrier 1, recesses are provided into which the yoke 6 can be fitted after embedding. In comparison to the electronic components 2, yoke 6 is insensitive against any environmental influences and therefore is not embedded in this application example but subsequently fitted to the embedded arrangement. The yoke 6, which is pushed sideways over the spool, is designed as a C-shaped yoke and features a bead 10 on its top and bottom sides. Here, within the spool body 3, the beads 10 of the yoke 6 are positioned centrally above the cavity, into which the valve dome 11 is later introduced. Furthermore, in addition to the valve control device, this figure also shows the hydraulic assembly 12, in particular the valve unit, whose valve domes 11 protrude into the spool body 3.

In order to produce such an embedded valve control device, it makes sense to set up the embedding tool such that it also forms domes that are introduced into the spool body and on which the spools are fixed during the embedding process. Before embedding the spool bodies 3 have been connected with the circuit carrier 1. Here, the connection pins 7 of the spool bodies 3 do not only provide the electrical but also the mechanical connection, by means of which the circuit carrier 1 is at least partially positioned within the embedding tool.

FIG. 2 shows the spool arrangement with the circuit carrier before embedding. The two spools 5 shown here each consist of a spool body 3, on which the spool windings 4 are mounted. The connections 7 of the spools 5 have not been fitted symmetrically with regard to the spool axis but mounted on one side. The spool connections 7 are inserted through the boreholes of the circuit carrier 1, in particular the printed circuit board, and are then fixed in position by means of pressing forces or soldering. They form a fixed unit and can be embedded together. Furthermore, there is a free space between the spools 5 and the printed circuit board 1. The side-mounted connections and the free space are used to create mounting space for the yoke which is not shown in this figure and which is pushed sideways over the spools after embedding.

The FIGS. 3a and 3b show the spool body. In FIG. 3a as a side view, and in FIG. 3b as a front view. Here, the connections 7 are fed out to one side of the spool body 3. The connections 7 do not only have the task to provide an electrical contact between the circuit carrier and the spool but also support the printed circuit board—as shown in FIG. 2—during the embedding process. For this reason the connections 7 must be dimensioned such that they are sufficiently stable to be able to withstand the press-fitting or soldering processes, and to support the circuit carrier. Moreover, they must be arranged such that they do not obstruct the yoke. The diameter of the cavity in the inside of the spool body must be selected to be sufficiently large so that the permissible tolerances, coming from the arrangement of the valve domes in the valve unit, can be compensated for. This takes account of the fact that the embedded spool bodies with windings will later be arranged in a fixed and immovable position in the compound. The spool body consists of synthetic material.

The FIGS. 4a and 4b show the yoke in different perspectives. In FIG. 4a as a side view, and in FIG. 4b as a front view. As can be seen from the figures, the yoke 6 is designed as a C-shaped yoke and features a bead 10 on its top and bottom sides, into which the valve dome is later inserted. The yoke 6 is pushed over the spool body as shown in FIGS. 3a and 3b. As the yoke 6 which consists of sheet metal can only be mounted after embedding, this may also be located movably so that the interior diameter of the beads 10 does not need to compensate for all tolerances coming from the arrangement of the valve domes in the valve unit. Tolerance compensation is effected by means of the movability of yoke 3.

FIG. 5 shows an embedded valve control device with metal plate 13 and with the outline of a valve unit 12. In the compound 8, there is the circuit carrier 1, in particular a printed circuit board populated with the electronic components 2. The electronic components 2 may either be encapsulated in a housing or be mounted on the circuit carrier 1 as a blank chip. At the same time spools are mounted on the circuit carrier 1, which feature a spool body 3 and windings 4. Between the circuit carrier 1 and the spools, a metal plate 13 is located. The metal plate 13 features insets 14 on to which the spool body 3 is pushed. The metal plate 13, in this embodiment, has two functions. Mainly, it is used as a component part of the yoke, and, on the other hand, it also serves as a metal body to dissipate the heat from the power components mounted on the circuit carrier 1 . The spool bodies 3 and the windings 4, connected with the metal plate 13—hereinafter also designated as yoke plate 13—and the circuit carrier 1 represent the electric magnets by means of which the valves of valve unit 12 are operated via the valve domes 11. The electric spool connections 7, mounted on the side of the spool body 3, protrude into the printed circuit board 1. In this figure, two spools are shown that are facing each other so that their side-mounted spool connections 7 are located next to one another. This setup is particularly space-saving. The spools and the circuit carrier 1 are completely embedded, excluding the inside of the spool. In the inside of the spool, the interior spool body 3 is visible. The external surfaces of the spool body 3 and the spool windings 4 are positively covered by the compound 8. This embedded arrangement protects all components, in particular the electronic components 2, against unfavorable environmental conditions such as e.g. water, humidity, and dust. In this case, the compound 8 consists of epoxy resin. The compound 8 will become rigid when the arrangement has hardened. The embedded components such as spools, circuit carrier 1, yoke plate 13, and electronic components 2 are fixed in position by the compound. With this setup, there is no longer any need for a housing. The compound 8 itself provides the housing. In the area between the individual spools, recesses are provided into which the yoke bell 15 can be fitted after embedding. In comparison to the electronic components 2, yoke bell 15 is insensitive against any environmental influences and therefore is not embedded in this application example but subsequently fitted to the embedded arrangement. The yoke bell 15, which is pushed either from above or below over the spool, is designed as a bell-shaped yoke and features a bead 10 to one side. On the opposite side, this bead is shown by the inset 14 of the yoke plate 13. Here, within the spool body 3, the bead 10 and the inset 14 of the yoke plate 13 are positioned centrally on the cavity, into which the valve dome 11 is later introduced. Instead of the yoke bell 15, which completely encapsulates the spool winding 4, it is also possible to use a U-shaped yoke that does not cover the embedded spool winding on two sides. Furthermore, in addition to the valve control device, this figure also shows the hydraulic assembly 12, in particular the valve unit, whose valve domes 11 protrude into the spool body 5.

In order to produce such an embedded valve control device, it makes sense to set up the embedding tool such that it also forms domes that are introduced into the valve body and on which the spools are fixed during the embedding process. Before embedding the spool bodies 5 have been connected with the circuit carrier 1 and the metal plate 13. Here, the connection pins 7 of the spool bodies 3 do not only provide the electrical but also the mechanical connection, by means of which the circuit carrier 1 is at least partially positioned within the embedding tool. The positive connection between the valve body 3 and the inset 14 of the metal plate 13 also provides a mechanical fixing during the embedding process.

FIG. 6 shows the spool arrangement with the circuit carrier and the yoke plate before embedding. The two spools 5 shown here each consist of a spool body 3, on which the spool windings 4 are mounted. The connections 7 of the spools 5 have not been fitted symmetrically with regard to the spool axis but mounted on one side. The spool connections 7 are inserted through apertures 17 of the yoke plate 13 into the boreholes of the circuit carrier 1, in particular the printed circuit board, and are then fixed in position by means of pressing forces or soldering. The yoke plate 13 is fixed in position by positively introducing the insets 14 of the yoke plate 13 into the spool body 3. Spool body 3, circuit carrier 1, and metal plate 13 form a fixed unit and can be embedded together. Furthermore, there is a free space between the individual spools. The free space is used to create mounting space for the yoke bell which is not shown in this figure and which is pushed either from above or below over the spools after embedding.

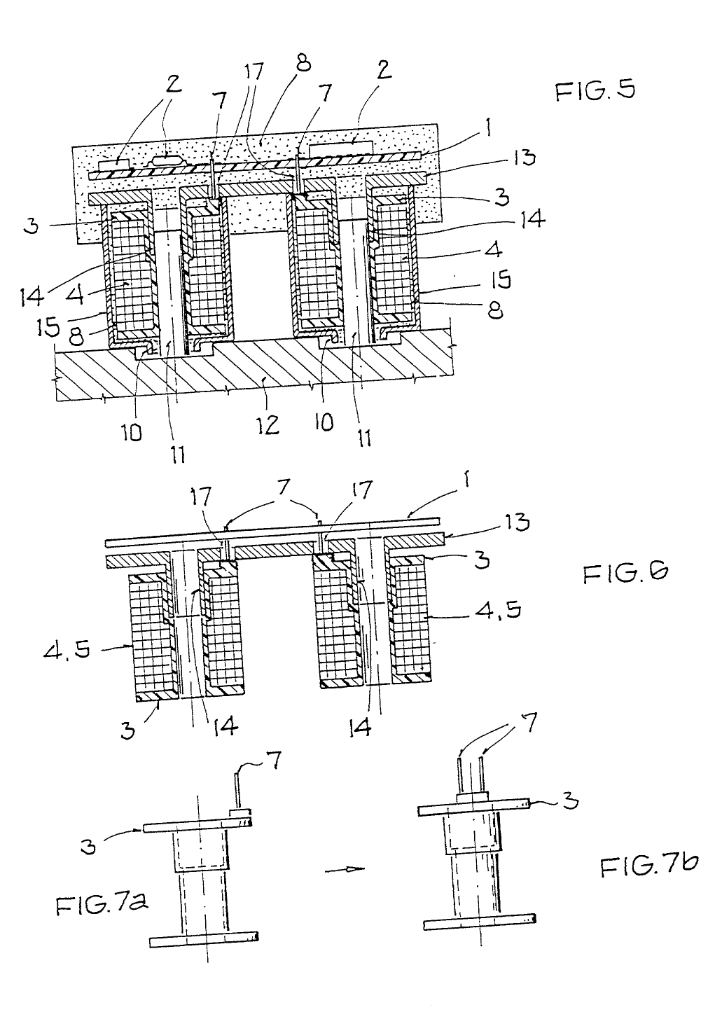

The FIGS. 7a and 7b show the spool body. In FIG. 7a as a side view, and in FIG. 7b as a front view. Here, the connections 7 are fed out to one side of the spool body 3. The connections 7 do not only have the task to provide an electrical contact between the circuit carrier and the spool but also support the printed circuit board—as shown in FIG. 6—during the embedding process. For this reason the connections 7 must be dimensioned such that they are sufficiently stable to be able to withstand the press-fitting or soldering processes, and to support the circuit carrier. Moreover, they must be arranged such that they do not obstruct the yoke bell. The cavity on the inside of the spool body features different diameters. The smaller diameter on the one side of the cavity in the inside of the spool body must be selected to be sufficiently large so that the permissible tolerances, coming from the arrangement of the valve domes in the valve unit, can be compensated for. This takes account of the fact that the embedded spool bodies with windings will later be arranged in a fixed and immovable position in the compound. The larger diameter on the other side, together with the sheet thickness of the yoke plate insets, must again yield the smaller diameter. The spool body consists of synthetic material.

The FIGS. 8a and 8b show the yoke bell in different perspectives. In FIG. 8a as a side view, and in FIG. 8b as a front view. As can be seen from the figures, the yoke bell 15 is designed as a pot-shaped yoke and features a bead 10 on one side, into which the valve dome is later inserted. The yoke bell 15 is pushed over the spool body as shown in FIGS. 7a and 7b. As the yoke bell 15 which consists of sheet metal can only be mounted after embedding, this may also be located movably so that the interior diameter of the bead 10 does not need to compensate for all tolerances coming from the arrangement of the valve domes in the valve unit. Tolerance compensation is effected by means of the movability of yoke bell 3.

Instead of a yoke bell, the FIGS. 9a and 9b show a U-shaped yoke 16 in different perspectives. In FIG. 9a as a side view, and in FIG. 9b as a front view. As shown in the figures, yoke 16 is U-shaped that is, it does not completely encapsulate the spool in the same way as the bell-shaped yoke but is open on two sides. This setup also features a bead 10 on one side, into which the valve dome is later inserted. The U-shaped yoke 16 is pushed over the spool body as shown in FIGS. 7a and 7b. As the U-shaped yoke 16 which consists of sheet metal can only be mounted after embedding, this may also be located movably so that the interior diameter of the bead 10 does not need to compensate for all tolerances coming from the arrangement of the valve domes in the valve unit. Tolerance compensation is effected by means of the movability of the U-shaped yoke 16.

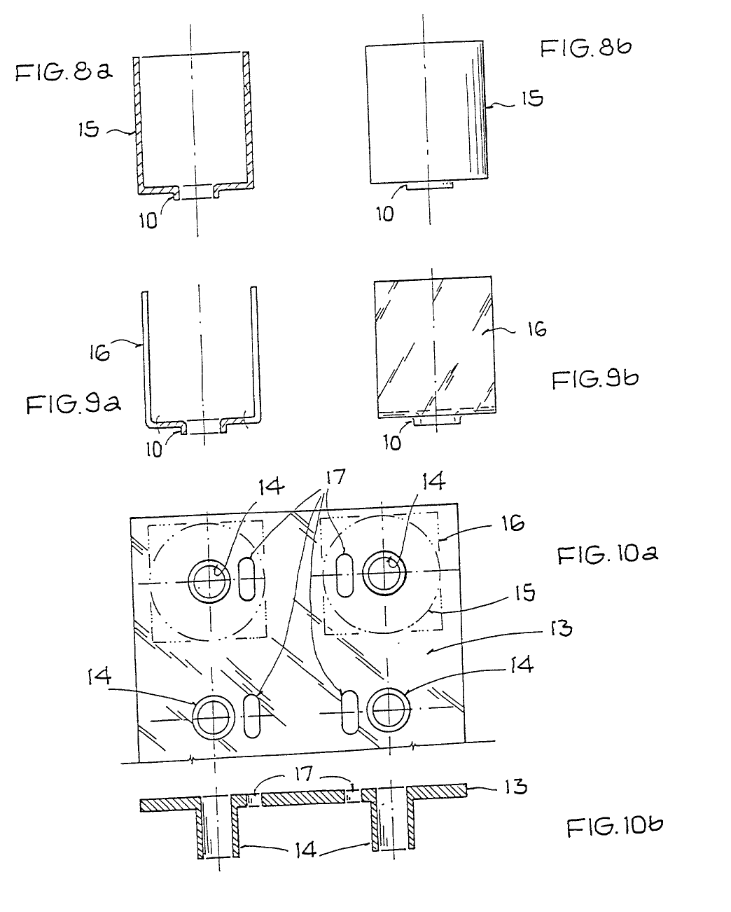

FIG. 10a shows the yoke plate 13 from below before assembly together with the other components and before embedding. The valve spools are pushed onto the circular insets 14. Next to the insets 14 there are apertures 17 to provide for the later feeding of the spool connections through the yoke plate to the circuit carrier. In oder to illustrate more clearly the later setup, this figure also shows the plan view of the yoke bell 15 and the U-shaped yoke 16, which, respectively, together with the yoke plate form the yoke for a spool.

FIG. 10b shows the cross-section view through the yoke plate. The metal yoke plate 13 features insets 14 which protrude from the yoke plate level. They are later introduced into the inside of the spool. The apertures 17 in the yoke plate 13 provide for the later making of the spool connections, which represent the electrical and mechanical connection to the circuit carrier.

For the embodiments shown it would seem obvious that the positively applied compound does not need to be homogeneous but may consist of different materials, and that the different materials can also be fitted in stages.

In addition, the yoke components 6, 15, 16, that, in the embodiments are not located underneath the compound, can also be embedded positively together with the other components, thus saving a further assembly process step.

What is claimed is:

1) Valve control device consisting of a circuit carrier (1) and valve spools (5) which are connected electrically with the circuit carrier (1) as well as with a housing accommodating the circuit carrier (1) and the valve spools (5) wherein the circuit carrier (1) and the valve spools (5) are arranged within a joint positive protective cover as a housing and wherein this protective cover consists of a compound (8).

2) Valve control device according to patent claim 1 wherein a metal plate (13) is additionally embedded in the compound (8) which serves as a housing.

3) Valve control device according to patent claims 1 or 2 wherein yoke components (6, 15, 16) are additionally embedded in the compound (8) which serves as a housing.

4) Valve control device according to patent claim 2 wherein a bell-shaped yoke (15) is located above the embedded spool (5).

5) Valve control device according to patent claim 2 wherein a U-shaped yoke (16) is located above the embedded spool.

6) Valve control device according to patent claim 1 wherein a C-shaped yoke (6) is located to one side of the embedded spool (5).

7) Valve control device according to patent claims 1 or 2 wherein the protective cover consisting of compound (8) is hard and watertight.

8) Valve control device according to patent claims 1 or 2 wherein the compound (8) consists of epoxy resin.

9) Process for the manufacture of a valve control device by means of an embedding tool according to claim 1 wherein
the circuit carrier (1) is connected mechanically with the electronic components (2) and the spools (5),
the spools (5) are pushed onto the domes of the embedding tool,
the spools (5) are embedded together with the circuit carrier (1), and subsequently
the compound (8) is allowed to harden.

10) Process for the manufacture of a valve control device by means of an embedding tool according to patent claim 2 wherein
the circuit carrier (1) is connected mechanically with the electronic components (2), the metal plate (13), and the spools (5),
the spools (5) are pushed onto the domes of the embedding tool,
the spools (5) are embedded together with the circuit carrier (1) and the metal plate (13), and subsequently
the compound (8) is allowed to harden.

11) Valve control device, manufactured by a process according to patent claims 9 or 10 wherein the mechanical connection between circuit carrier (1) and spool (5) also is the electrical connection (7) at the same time.
